(19) United States
(12) Patent Application Publication
(10) Pub. No.: US 2018/0199011 A1
(43) Pub. Date: Jul. 12, 2018

(54) SYSTEMS AND METHODS FOR DOCUMENTING EXHIBIT EXPERIENCES

(71) Applicant: Jasmine Zimmerman Studio LLC, Seattle, WA (US)

(72) Inventor: Jasmine Zimmerman, Seattle, WA (US)

(21) Appl. No.: 15/404,115

(22) Filed: Jan. 11, 2017

(51) Int. Cl. H04N 7/18; H04N 5/232

(52) U.S. Cl. CPC H04N 7/188; H04N 5/23238; H04N 5/23216; H04N 5/23293; H04N 5/23206

(57) ABSTRACT

Imaging systems integrated into exhibition spaces are disclosed herein. Methods of capturing images of visitors experiencing exhibits are also provided. Various embodiments are directed to systems and methods for capturing and sharing an image of a visitor with an exhibit.

### TECHNICAL FIELD

This disclosure relates to imaging technology, and more specifically, to imaging systems integrated into exhibition spaces. Various embodiments are directed to systems and methods for capturing and sharing an image of an individual or group experiencing an exhibition space.

### BACKGROUND

Throughout history, humans have shown a desire to document their experiences order to preserve their memories and share their experiences with others. For this reason, photography and videography services are often present at special events, destinations, and other attractions. Some special events and destinations provide photo booths for this purpose. Photo booths are typically enclosed kiosks that allow individuals to capture images of themselves on demand without the need for a photographer or a personal camera. Often an individual sits or stands in the kiosk in from of a backdrop, and the backdrop provides a two-dimensional message or scene representative of the attraction. Conventionally, the photo booth prints the photograph onsite so that the individual has almost immediate access to the captured image. Recently, photo booths have been developed that transmit an electronic copy of the photograph to the individual via email or other electronic communication means.

Photo booths have many shortcomings though. A photo booth can be an inelegant, intrusive presence at a special attraction. Moreover, because an individual must step into an enclosure, the individual is effectively removed from the special event, destination, or other attraction. Accordingly, photo booths do not allow the individual to capture images of themselves with, in, or amidst the actual attraction. Photo booths fail to document the individual's actual experience with the attraction. Additionally, upon entering a photo booth, an individual's attention is often redirected onto themselves and their desire to capture a pleasing photograph; accordingly, photo booths can make it difficult for individuals to fully immerse themselves in the experience of the attraction. As an alternative, many event and destination coordinators instead employ professional photographers and/or videographers to walk around capturing images of guests. Often these photographs and videos are captured solely for the benefit of the host, and guests never receive copies of the images. In other situations, the photographs and videos are available for purchase; however, the images are often expensive, and it can be a hassle to provide the payment and contact information needed to purchase the images.

Accordingly, many individuals at events, destinations, and other attractions simply take their own photographs and videos. With the incorporation of high quality front facing cameras into smartphones and a continued rise in social media participation, the number of “selfie” (i.e., self-directed) photographs and videos being captured at museums, restaurants, weddings, concerts, and other attractions is increasing. Unfortunately, the desire to capture the perfect shot causes some individuals to focus their attention on photo or video acquisition, distracting them from the actual attraction at which they are present. Individuals sometimes become dangerously unaware of their surroundings when capturing images. Some individuals also become psychologically removed from the experience. The increase in distracted guests and image capture accessories such as “selfie sticks” can dramatically diminish the experience of all guests. It may hinder guests' abilities to focus on the artistic, educational, relaxation, celebratory, or other noteworthy qualities of an attraction. Pervasive camera usage can make it difficult for all guests to feel present and immersed in an experience.

Accordingly, there is a need for new and improved image capture systems and methods designed to capture, in an unobtrusive and inconspicuous manner, individuals experiencing events, destinations, and other attractions.

### SUMMARY

There is a need for new and improved systems and methods that capture an individual's experience of an exhibit without distracting from, interfering with, or interrupting the individual's experience. There is also a need for systems and methods that enable an individual to document and share his or her experience of an exhibit without distracting from, interfering with, or interrupting the experiences of others. There is a need for systems and methods that enable an individual to capture an image of himself or herself experiencing an exhibit without requiring a personal camera or photography accessories. There is a need for such captured images to be properly lighted, positioned, and composed such that the individual is pleased with the captured image. There is a need for systems and methods that allow an individual to electronically view and share one or more of the captured images with others. The present disclosure provides designs and embodiments that address one or more of these needs.

One aspect of the disclosure is directed to a system for capturing and sharing an image of a visitor experiencing an exhibit. In various embodiments, the system includes an mage capture device, a user input device, and a communication computing device. The image capture device is coupled to a support structure located on a perimeter of, or within, an exhibition space and is configured to capture an image. The image capture device includes an image sensor and a lens and is oriented such that an exhibit within the exhibition space is in a field of view of the lens. The user input device is configured to receive contact information from a visitor. Either the user input device or a separate activation device is configured to generate a trigger signal in response to detecting a triggering event, the trigger signal being transmittable to the image capture device. In various embodiments, the image capture device is configured to capture an image of the visitor with the exhibit in response to receiving the trigger signal. In various embodiments, the triggering event is associated with the visitor preparing to experience, or experiencing, the exhibit. In some embodiments, the communication computing device forms a portion of, or is communicatively coupled to, at least the image capture device and is configured to transmit the captured image to a remote computing device. In some embodiments, the system further includes a lighting device formed of one or more light sources oriented to illuminate the visitor and/or the exhibit when the visitor is positioned proximate to the exhibit and in a field of view of the image capture device.

In some embodiments, the image capture device is configured to capture photographs an videos. The image capture device of some embodiments is a digital camera or camcorder. The image capture device of some embodiments is a digital single lens reflex (DSLR) camera. The image sensor may include one or more of a charge-coupled device (CCD) and a complementary metal-oxide-semiconductor (CMOS). In some embodiments, the lens of the image capture device is a 14-24 mm, fisheye lens, or other lens suitable for capturing wide angles.

In some embodiments, the support structure is formed of, or includes, a wall, pillar, fence, gate, pole, or other partition. In some embodiments, the support structure defines at least a portion of the perimeter of the exhibition space. In some embodiments, the support structure includes a front surface facing the exhibit and a rear surface facing away from the exhibit. In some such embodiments, the image capture device is integrated into the support structure such that the lens is protected by a transparent covering flush with, or forming, the front surface. In some such embodiments, the image capture device is accessible from the rear surface.

In some embodiments, the user input device includes a display screen having a graphical user interface displayed thereon, and one or more of: a keyboard, touch-responsive technology in the display screen, a mouse, and a trackpad. The contact information received at the user input device may include one or more of: a name, a mobile telephone number, an email address, and a social media user name.

In some embodiments, the activation device is, or includes, a sensor, and the triggering event is the movement or positioning of the visitor at a sensor-monitored location of the exhibition space. The sensor may include, for example, one or more of a motion sensor, a laser sensor, a photoelectric sensor, a pressure sensor, and an acoustic sensor. In other embodiments, the user input device generates the trigger signal, and the triggering event is the entry of the visitor's contact information into the user input device. In some embodiments, components of the system are programmed to delay capture of the image by a pre-programmed duration of time following detection of the triggering event.

In some embodiments, the communication computing device includes one or more computing devices integrated into, physically coupled to, or communicatively coupled to: the image capture device, the user input device, and/or the activation device. The remote computing device to which the communication computing device transmits the captured image may be a network computing device or a visitor's computing device. In various embodiments, the communication computing device: relays trigger signals to the image capture device, receives the captured image from the image capture device, receives contact information from the user input device, transmits the captured image to the network computing device, transmits contact information to the network computing device, and/or transmits the captured image to the visitor's computing device using the contact information of the visitor.

An additional aspect of the disclosure is directed to a method for capturing and sharing an image of a visitor experiencing an exhibit. The method of various embodiments is performed by one or more computers. In some embodiments, the method includes: receiving contact information from a visitor at a user input module; detecting a triggering event, the triggering event being associated with the visitor preparing to experience, or experiencing, an exhibit in an exhibition space; transmitting a trigger signal to an image capture module to trigger the image capture module to capture an image of the exhibit in response to the triggering event; receiving the image from the image capture module; and transmitting the image to a computer associated with the visitor or to a network computing device for storage. In some embodiments, the contact information of the visitor is also transmitted to the network computing device and the network computing device transmits a link for the stored image to the visitor using the visitor's contact information. In various embodiments, the image capture module includes a lens oriented such that both the exhibit and the visitor are in a field of view of the lens when the visitor is positioned proximate to the exhibit. In such embodiments, both the exhibit and the proximately located visitor are captured in the image.

A further aspect of the disclosure is directed to an architectural structure. The architectural structure of various embodiments includes a partition having a first surface facing toward an exhibit and a second surface facing away from the exhibit. At least a portion of the first surface is formed of a transparent covering. In some embodiments, the transparent covering is a two-way mirror. The structure also includes an image capture device integrated into the partition. The image capture device of various embodiments includes an image sensor and a lens. The image capture device is positioned within the partition such that: the lens faces, and is protected by, the transparent covering; and the image capture device is accessible via the back surface. The structure may additionally include one or more sensors configured to sense the presence of a visitor approaching, near, or at an exhibit. The sensors may be, for example, one or more of a motion, laser, photoelectric, acoustic, and pressure sensor. The one or more sensors may be positioned in or on the partition or provided in or on a second partition. The one or more sensors are communicatively coupled to the image capture device, and the image capture device is programmed to capture an image in response to receiving a signal from the sensor(s) indicative of the presence of a visitor. In some embodiments, the structure further includes one or more lights oriented to illuminate the exhibit and/or a visitor positioned proximate to the exhibit. In some embodiments, the structure further includes a user input device configured to receive contact information from the visitor. In some embodiments, the structure is configured to directly or indirectly transmit the captured image to the visitor using the visitor's contact information.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 depicts a functional block diagram of one embodiment of an image capture system.

FIGS. 2A-2C provide schematic drawings depicting a cross-sectional side view, front view, and rear view, respectively, of one embodiment an image capture system.

FIG. 3 depicts a functional block diagram of one embodiment of a computing device included within the image capture system.

FIG. 4 provides a schematic drawing depicting a partial perspective view of one embodiment of an image capture system.

FIG. 5 provides a schematic drawing depicting a partial perspective view of another embodiment of an image capture system.

FIG. 6 provides a schematic drawing depicting a cross-sectional top view of one embodiment of an image capture system that includes a plurality of exhibits.

FIG. 7 provides a schematic drawing depicting a cross-sectional side view of one embodiment of an image capture system.

FIG. 8 provides a schematic drawing depicting a cross-sectional side view of another embodiment of an image capture system.

FIG. 9 depicts a flow chart illustrating one embodiment of a method of operations performed by an image capture system.

FIG. 10 depicts a flow chart illustrating one embodiment of a method of using or interacting with an image capture system.

The illustrated embodiments are merely examples and are not intended to limit the invention. The schematics are drawn to illustrate features and concepts and are not necessarily drawn to scale. Throughout the various figures, like reference numbers indicate like elements.

### DETAILED DESCRIPTION

The following description is not intended to limit the invention to these described embodiments, but rather to enable any person skilled in the art to make and use this invention. Other embodiments may be utilized and modifications may be made without departing from the spirit or the scope of the subject matter presented herein. Aspects of the disclosure, as described and illustrated herein, can be arranged, combined, and designed in a variety of different configurations, all of which are explicitly contemplated and form part of this disclosure.

Throughout and within this specification, one or more publications may be referenced to more fully describe the state of the art. The disclosures of any such references are incorporated herein by reference in their entireties as though they form part of this disclosure.

Unless otherwise defined, each technical or scientific term used herein has the same meaning as commonly understood by one of ordinary skill in the art to which this disclosure belongs.

As used in the description and claims, the singular form “a”, “an” and “the” include both singular and plural references unless the context clearly dictates otherwise. For example, the term “a sensor” may include, and is contemplated to include, a plurality sensors. At times, the claims and disclosure may include terms such as “a plurality,” “one or more,” or “at least one;” however, the absence of such terms is not intended to mean, and should not be interpreted to mean, that a plurality is not conceived.

Unless otherwise specified, the term “about” or “approximately,” when used before a numerical designation or range (e.g., to define a distance), indicates approximations which may vary by (+) or (−) 5%, 1%, or 0.1%. All numerical ranges provided herein are inclusive of the stated start and end numbers. The term “substantially” indicates mostly (i.e., greater than 50%) or almost all a substance, component, or feature.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed invention. “Consisting of” shall mean that the devices, systems, and methods include the recited elements and exclude anything more, than a trivial or inconsequential element or step. Embodiments defined by each of these transitional terms are within the scope of this disclosure.

Embodiments of the disclosed subject matter may be referred to herein individually or collectively by the term “invention” merely for convenience and without intending to voluntarily limit the scope of this disclosure to any single invention or inventive concept, if more than one is disclosed.

### Systems and Devices

Disclosed herein are new and useful systems, devices, and structures for capturing and sharing images of an individual's experience within a space without distracting from, interfering with, or interrupting the individual's experience or the experience of others.

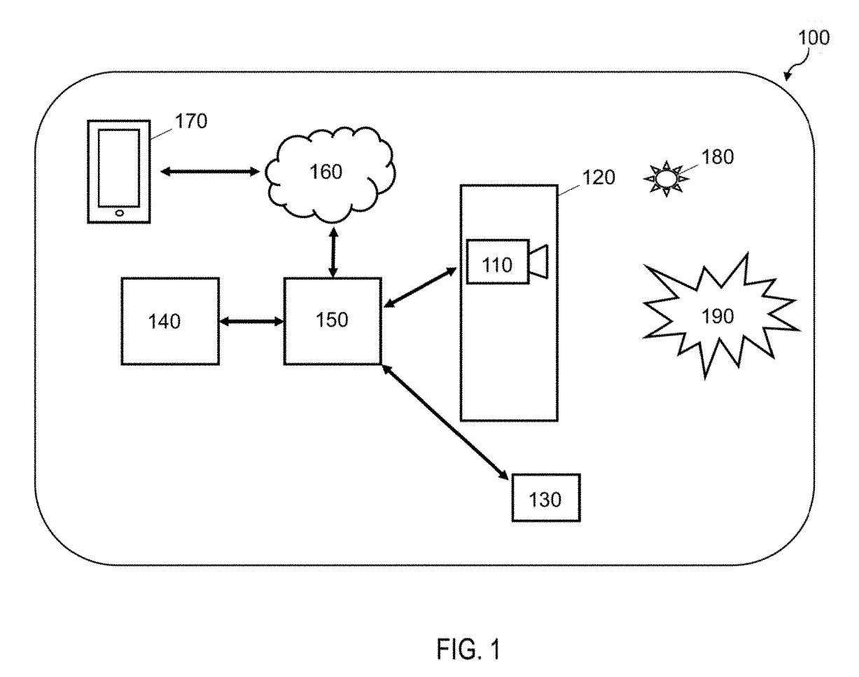

A functional block diagram of one embodiment of an image capture system is provided in FIG. 1. As shown, the image capture system 100 includes: an image capture module 110, a support module 120, an activation module 130, a user input module 140, and a communications module 150. The system may further include a network computing device 160, a visitor computing device 170, a lighting module 180, and/or an exhibit 190. The various modules described herein are functional modules. That is, the modules represent various functions performed by the system 100. The system 100 may be structured in any way that is suitable to perform these various functions. For example, in some embodiments, each functional module corresponds to a different structural element or device; in some embodiments, a plurality of devices are provided to perform one function; and in some embodiments, one device performs a plurality of functions.

The image capture module 110 is configured to capture photographs and/or videos. The components performing the functions of the image capture module 110 are fully or partially encased by the support module 120 such that the components of the image capture module 110 are supported, protected, and optionally, hidden from view. The support module 120 is configured to support the components of the image capture module 110 in a stable position.

In various embodiments, the support module 120 is positioned on a perimeter of, or within, an exhibition space. The exhibition space may be indoors or outdoors and it may be fully enclosed, partially enclosed, or a fully open space. As used herein, an exhibition space is any three-dimensional space, in which an exhibit 190 is located. An exhibit, as used herein, refers to anything intended for individuals to visit and experience. The exhibit 190 may be an event, destination, or object of interest. For example, the exhibit 190 may be an art display, an art installation, a museum display, a museum installation, a science center attraction, an architectural or design piece, a musical, theatrical, or other artistic performance, a thud or drink item presented at a restaurant, an animal, a scenic vista, a race or other sporting event, or any other attraction intended to be experienced by individuals. As used herein, a visitor may refer to any individual or group of individuals present at an exhibit.

In various embodiments, the image capture module 110 is configured to automatically capture one or more images of a visitor within the exhibition space as the visitor observes, interacts with, or otherwise experiences the exhibit 190. In order to automatically capture such images without interrupting the experience of the visitor, the system 100 of some embodiments includes an activation module 130 configured to sense a triggering event indicative of a visitor preparing to experience, or experiencing, the exhibit. The triggering event may include, for example, a visitor: inputting contact information into a user input device prior to approaching the exhibit; entering the exhibition, space; moving within the exhibit space; crossing a particular location within the exhibition space; stepping into a particular region near the exhibit 190; or picking up, touching, or otherwise interacting with the exhibit 190. The activation module 130 is communicatively coupled, directly or indirectly, to the image capture module 10 and configured to transmit a trigger signal to the image capture module 110 in response to sensing or detecting the triggering event. The trigger signal may activate the image capture module 110, triggering it to capture an image of the exhibit at a point in time when a visitor is at near the exhibit 190. In some embodiments, either the activation module 130 or the image capture module 110 is pre-programmed with a delay so that a preset duration of time passes, following the triggering event, before the image capture module 110 captures the image. For example, in some embodiments, the component(s) performing the functions of the activation module 130 wait a preset amount of time before transmitting the trigger signal to the image capture module 110 components. In other embodiments, the trigger signal is generated upon sensing a triggering event, and components of the image capture module 110 are programmed to wait a preset amount of time before capturing an image. In this manner, the system 100 can detect when a visitor is, at or approaching the exhibit 190 and capture an image of the visitor experiencing the exhibit 190 without interrupting the focus of the visitor.

To facilitate the capture of a well-lit image of the visitor and the exhibit 190, the system 100 of some embodiments additionally includes a lighting module 180 configured to provide illumination to the exhibit and/or a visitor positioned proximate to the exhibit. As used herein, proximate refers to any location positioned closely enough to the exhibit to enable a visitor to closely observe, hear, touch, handle, or otherwise experience the exhibit. In some embodiments, a location proximate to the exhibit refers to a location directly under or over an exhibit. In some embodiments, a location proximate to the exhibit refers to a location within arm's length of the exhibit. In some embodiments, a location proximate to the exhibit refers to any location surrounding the exhibit that is within the viewing angle (i.e., field of view) of an image capture device.

In various embodiments, the system 100 is further configured to automatically share the images captured by the image capture module 110. The system 100 of such embodiments further includes a communications module 150 for sharing (i.e., transmitting) images. The system 100 may also include a network computing device 160 for receiving, storing, and cataloging images. In some embodiments, the network computing device 160 stores the image as a stored image in a database. In various embodiments, the communications module 150 is communicatively coupled to the image capture module 110 and the network computing device 160 and is configured to transmit images from the image capture module 110 to the network computing device 160. In various embodiments, the network computing device 160 is formed of one or more remote computing devices. In some embodiments, the network computing device 160 is a cloud-based server formed of an application server, an internet server, a database server, or a combination thereof. The network computing device 160 may be maintained and/or accessible by a host, a system administrator, a facility or event coordinator, or other individual or entity associated with managing, hosting, maintaining, or owning the image capture system 100 or the exhibit 190.

In some embodiments, the system 100 is also configured to automatically share the captured image with the visitor captured in the image. In such embodiments, the system 100 may additionally include a user input module 140 configured to be manipulated by a visitor for the purposes of entering the visitor's contact information into the system. The contact information received through the user input module 140 may include one or more of: a name, a mobile telephone number, an email address, and a social media user name or handle. In various embodiments, the user input module 140 is communicatively coupled to the communications module 150, and the communications module 150 is configured to transmit the visitor's contact information from the user input module 140 to the network computing device 160.

In some embodiments, the network computing device 160 is configured to transmit the image or a link to the stored image to a visitor's computing device 170 using the contact information provided by the visitor. For example, the image or a link. to the image may be sent via an SMS text or other mobile message to the visitor's computing device 170 using the visitor's phone number or via an email to the visitor's computing device 170 using the visitor's email address. Additionally or alternatively, the network computing device 160 may be programmed to upload the image to a social media platform with the visitor tagged in the image using the visitor's handle or user name. In other embodiments, the communications module 150 may be configured to use the visitor contact information directly to text, email, or otherwise transmit the image to the visitor's computing device 170. The visitor's computing device 170 may be any personal computing device such as a smartphone, smartwatch, tablet, notebook, laptop, or desktop computer.

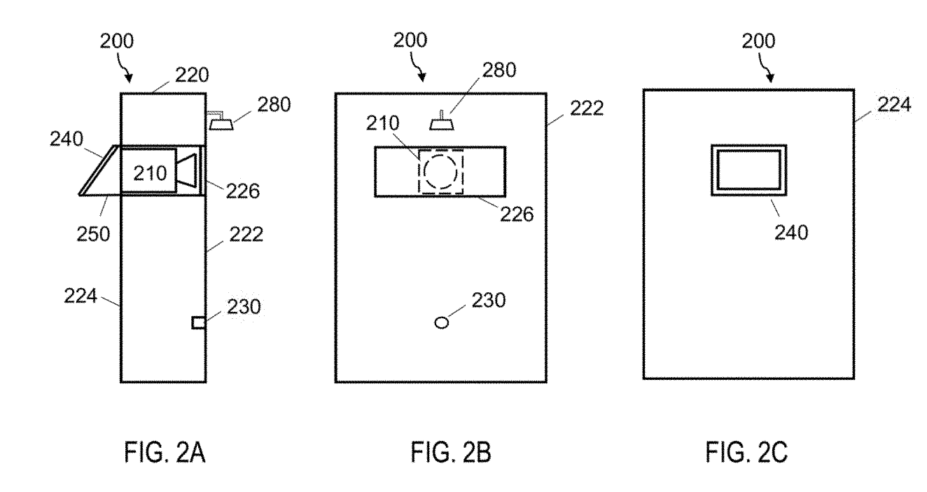

Any suitable structural components may be used to perform the functions of the image capture system 100 described above. FIGS. 2A-2C provide a cross-sectional side view, front view, and rear view, respectively, of one example of an image capture system depicted with structural components. The image capture system 200 of FIGS. 2A-2C includes: an image capture device 210 integrated into a support structure 220, a sensor 230, a user input device 240, and a lighting component 280.

The image capture device 210 performs the functions of the image capture module 110 described above with reference to FIG. 1. The image capture device 210 includes an image sensor and a lens. Any suitable image sensor and lens may be used. In some embodiments, the image sensor is a charge-coupled device (CCD) or a complementary metal-oxide-semiconductor (CMOS). In some embodiments, the lens is a 14-24 mm lens, a fisheye lens, or another lens configured for capturing wide angles or any other desired effect. The image capture device 210 is oriented such that an exhibit 290 is within the field of view of the lens. In some embodiments, the image capture device 210 is, or includes, a digital single lens reflex (DSLR) camera or other digital camera. In some embodiments, the image capture device 210 is, or includes, a GoPro® or other action camcorder or digital video camera. The image capture device 210 further includes an image capture computing device programmed to enable automatic functioning of the image capture device 210. The image capture computing device may be programmed, for example, to activate the components of the image capture device 210 and take a photograph or record a video in response to receiving a trigger signal. The image capture Computing device may be further programmed, for example, to transmit the captured photographic or video image to another computing device.

The image capture device 210 is integrated into the support structure 220. The support structure 220 provides the structural support functionality of the support module 120. The support structure 220 may be a wall, pillar, fence, beam, gate, pole, pylon, barricade, artificial tree, archway, or any other partition or structure configured to support the image capture device 210 in a stable position.

In some embodiments, the functions of the activation module 130, including sensing a triggering event and generating a trigger signal, are performed by a sensor 230. The sensor 230 is, or includes, a sensing element positioned on or within the support structure 220 or on a nearby door, wall, or other structure positioned on the perimeter of, or within, the exhibition space. The sensor may be a motion sensor, a laser sensor, a photoelectric sensor, a pressure sensor, an acoustic sensor, or any other sensor configured to detect the presence or position of the visitor at or near the exhibit. In some embodiments, the sensor 230 includes a sensor computing device configured to: receive, filter, and process signals received from the sensing element; detect a triggering event; generate a trigger signal when the triggering event is detected; and transmit the trigger signal to another computing device.

The user input device 240 is configured to perform the functions of the user input module 140. In various embodiments, the user input device 240 includes a user input computing device with a display screen. The user input device 240 further includes one or more user input mechanisms, including one or more of: a keyboard, a keypad, touch-responsive technology in the display screen (i.e., a touch screen), a mouse, a trackpad, a joystick, buttons, knobs, and other suitable user input mechanisms. Together, the components of the user input device 240 are programmed and configured to: display a graphical user interface requesting contact information from a visitor, receive inputs from a visitor entering contact information into the graphical user interface via the user input mechanism, and store the contact information. The user input device 240 may be further programmed to transmit the contact information to another computing device or to use the contact information to send a captured image to the visitor.

In some embodiments, no sensor 230 is provided. The user input device 240 may instead be further programmed to perform the functions of the activation module 130. In such embodiments, the user input device 240 functions to both receive a visitor's contact information and generate a trigger signal to activate the image capture device 210. The visitor's entry of contact information may function as the triggering event. Such an embodiment may be suitable for systems that are arranged such that visitors enter their contact information into the user input device 240 immediately before approaching and experiencing the exhibit 290. In such an arrangement, the user input device 240 is, directly or indirectly, communicatively coupled to the image capture device 210 and configured to transmit the trigger signal to the image capture device 210 following receipt of a visitor's contact information.

In some embodiments, the computing device of the image capture device 210, the sensor 230, or the user input device 240 is pre-programmed with a delay so that a preset duration of time passes, following the triggering event, before image acquisition. For example, in some embodiments, the sensor 230 or the user input device 240 is programmed to wait a preset amount of time, following detection of a triggering event, before transmitting the trigger signal. In other embodiments, the trigger signal is generated upon sensing a triggering event, and the image capture device 210 is programmed to wait a preset amount of time before capturing an image. Such a delay may help ensure that the visitor is properly positioned at the exhibit within the lens's field of view at the time the image is captured.

As shown in FIG. 2A, the support structure 220 includes a front surface or front portion 222 positioned to face towards an exhibit and a back surface or back portion 224 positioned to face away from the exhibit 290. In some embodiments, the system 200 is arranged such that the user input device 240 is placed on the back surface 224 or further away from the exhibit 290. For example, in embodiments where the support structure 220 is located on a perimeter of the exhibition space, the user input device 240 may be located outside of the exhibition space. In some embodiments, the system 200 is arranged such that the sensor 230 is positioned on, or integrated into, the front surface 222 of the support structure. In other embodiments, the sensor 230 is positioned on a door, within a doorway or archway leading to the exhibit 290, in the floor proximate the exhibit 290, or on another wall or structure within the exhibition space. With such arrangements, a visitor approaching an exhibit space first encounters the user input device 240 and is prompted to provide his or her contact information. The visitor may then proceed to move through a doorway or archway or past an edge of the support structure 220, thereby moving from the back side of the support structure 220 to the front side of the support structure 220. Once on the front side of the support structure 220, the visitor can see, hear, or otherwise experience the exhibit 290. The one or more sensors 230 within the exhibit space may enable the system 200 to detect when the visitor is within a field of view of the lens and in a location conducive for hearing, seeing, touching, or otherwise interacting with and experiencing the exhibit 290.

In some embodiments, the support structure 220 includes a hole or port extending through the support structure and sized to receive the image capture device 210. In the embodiment of FIG. 2, a transparent covering 226 covers the entrance to the port on the front side 222 of the support structure 220. The transparent covering 226 is flush with, or substantially flush with, the front surface 222. The lens of the image capture device 210 points towards the transparent covering 226. The transparent covering 226 may be made of glass, plastic, or any other transparent material. In some embodiments, the transparent covering is a two-way mirror configured such that the covering appears: transparent from the perspective of the image capture device 210 so that the exhibit and visitor are viewable and capturable by the image capture device 210, and reflective from the perspective of the visitor standing at or near the exhibit. In such embodiments, the image capture device 210 is fully obscured from the view of the visitor, with the visitor instead seeing himself or herself reflected from the transparent covering 226. In some embodiments, the transparent covering 226 is removable to facilitate access to the image capture device 210. In other embodiments, the image capture device 210 is accessible from the back side 224 of the support structure 220. For example, in FIG. 2, the user input device 240 and computing device 250 connected thereto may be movable or removable to access the image capture device 210.

A lighting device 280 may additionally be positioned within the exhibit space. The lighting device 280 is configured to perform the functions of the lighting module 180. The lighting device 280 may by any source of light suitable for facilitating illumination of the exhibit 290 and/or the visitor experiencing the exhibit. For example, the lighting device 280 may be an incandescent light, a halogen light, a light emitting diode, or any other desired light source. The lighting device 280 may be positioned to fully illuminate the exhibit 290 and the visitor's face, or it may be positioned so as to create backlighting, uplighting, silhouettes, shadows, or any other desired artistic lighting effect in the images.

The functions of the communications module 150 may be performed by one or more local computing units. As used herein, a local computing unit refers to a computing device that is positioned in or near the exhibition space and/or the support structure 220. The one or more computing units that perform the functions of the communications module 150 may be integrated into, or coupled to, one or more of the various devices described above. For example, in some embodiments, the computing unit of the image capture device 210 is configured to transmit captured images to the network computing device 160, and the computing unit of the user input device 240 is configured to transmit visitor contact information to the network computing device 160. In other embodiments, the image capture device 210 is electrically coupled to the user input device 240 such that the computing unit of the image capture device 210 is configured to receive contact information from the computing unit of the user input device 240 and/or the user input device computing unit is configured to receive captured images from the image capture device computing unit. In such embodiments, either the user input device computing unit or the image capture device computing unit is configured to transmit the captured images and associated contact information to the network computing device 160. In still other embodiments, a separate computing device 250 is provided within the system 200. The computing device 250 is electrically coupled to the image capture device 210, the user input device 240, and optionally, the sensor 230, and acts as an intermediary communication device. Such a computing device 250 may be configured to receive contact information from the user input device 240, transmit the contact information to the network computing device 160, receive trigger signals from the sensor 230 or the user input device 240, relay the trigger signals to the image capture device 210, receive captured images from the image capture device 210, transmit captured images to the network computing device 160, and/or transmit the captured images directly to the visitor's computing device using the contact information.

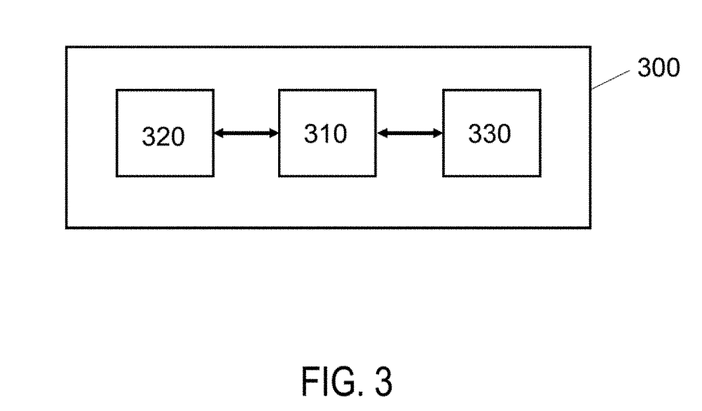

As described above, various devices provided within the image capture system 200 are computerized so that their functions are partially or fully automated. FIG. 3 provides a functional block diagram of one embodiment of a computing device representative of the various computing units and devices present within the system 200. That is, each computing unit and computing device present within the system 200 may include any of, or all, the functional components of the computing device 300 of FIG. 3. Although illustrated separately, it is to he appreciated that the various functional blocks of the computing device 300 need not be separate structural elements.

The computing device 300 of various embodiments includes a processing unit 310, which may be a general purpose microprocessor, a digital signal processor (DSP), a field programmable gate array (FPGA), an application specific integrated circuit (ASIC), or other programmable logic device, or other discrete computer-executable components designed to perform the algorithms and functions described herein. The processing unit 310 may also be formed of a combination of computing components, for example, a DSP and a microprocessor, a plurality of microprocessors, one or more microprocessors in conjunction with a DSP core, or any other suitable configuration.

The processing unit 310 is coupled, via one or more buses, to memory 320 in order to read information from and write information to the memory 320. The processing unit 310 may additionally or alternatively contain memory 320. The memory 320 can include, for example, processor cache. The memory 320 may be any suitable computer-readable medium that stores computer-readable instructions for execution by computer-executable components. For example, the computer-readable instructions may be stored on one or a combination of RAM, ROM, flash memory, EEPROM, hard disk drive, solid state drive, or any other suitable device. In various embodiments, the computer-readable instructions include software stored in a non-transitory format. The processing unit 310, in conjunction with the software stored in the memory 320, executes an operating system and any stored programs. Some methods described elsewhere herein may be programmed as software instructions contained within the memory 320 and executable by the processing unit 310.

The computing device 300 of various embodiments includes one or more network interfaces 330. In some embodiments, the computing device 300 includes one or both of: a first network interface configured for communication between other local computing units, and a second network interface configured for communication with a remote computing device. The one or more network interfaces 330 may be configured for wired or wireless transmission of data. In some embodiments, one or more of the local computing units may be electrically coupled together via a wired connection with data relayed via one or more buses. In some embodiments, a wireless network interface is provided to facilitate wireless communication between one or more of the local computing units. In some embodiments, one or more of the local computing units are wirelessly couplable to a remote computing device, such as the network computing device 160 and/or the visitor's computing device 170. The wireless network interface of some embodiments includes a receiver and transmitter for bi-directional communication. The receiver receives data and demodulates data received over a communication network. The transmitter prepares data according to one or more network standards and transmits data over a communication network. A communication antenna in the form of a transceiver may act as both a receiver and a transmitter. The various computing units and devices of the system 200 may be communicatively coupled to one or more local and/or remote computing devices via: a CDMA, GSM, LTE, or other cellular network, a Wi-Fi® protocol, a nearfield communications (NFC) protocol, a low energy Bluetooth® protocol, other radiofrequency (RF) communication protocol, any other suitable wireless communication protocol, or a cable internet, dial-up internet, or Ethernet connection, or any other wired or wireless means of connection.

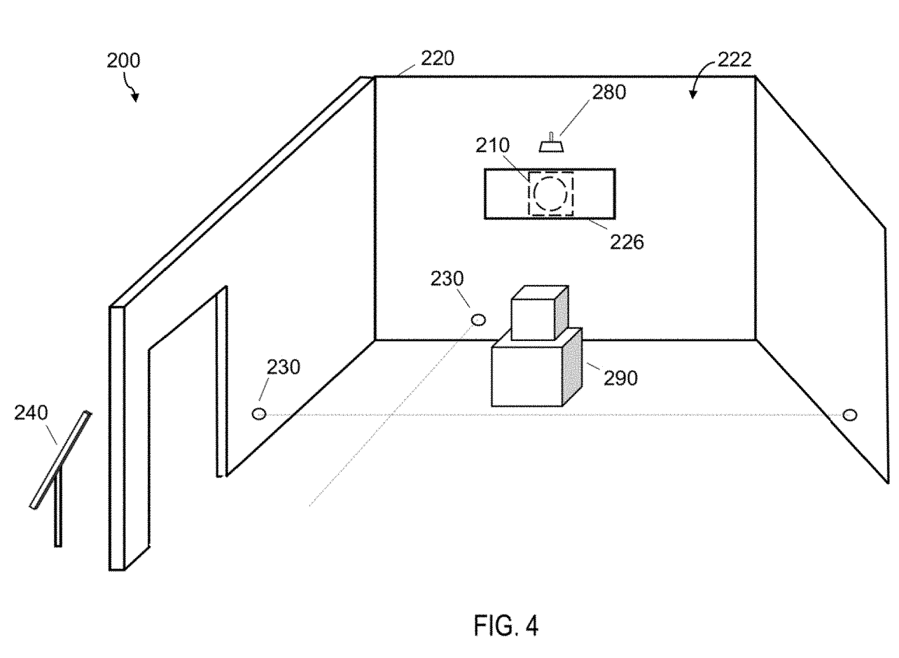

Another example of an image capture system 400 is provided in FIG. 4. In the provided example, the support structure 220 is formed of a partition such as an architecturally integral wall, false wall, or cubicle wall. The exhibition space of FIG. 4 is an enclosed space, and the support structure 220 defines at least a portion of the exhibition space's perimeter. The user input device 240 is positioned outside of the exhibition space near a rear side of the support structure 220. The support structure 220 has a hole bored through it with an image capture device 210 positioned within the hole. A transparent cover 226 is hung or otherwise attached to the front surface 222 of the support structure 220 so as to cover the hole and protect the lens of the image capture device 210.

A lighting device 280 is integrated into or attached to the support structure 220 and oriented to project light onto the exhibit 290 and/or areas proximate to the exhibit where a visitor may stand while experiencing the exhibit. In some embodiments, the lighting device 280 is angled to aim a light directly onto an area where a visitor will stand, proximate to the exhibit.

In the embodiment of FIG. 4, one or more sensors 230 are positioned within the exhibition space. In one embodiment, the one or more sensors 230 are photoelectric, sensors, such as, for example, through-beam (i.e., opposed), diffuse (i.e., proximity-sensing), or retro-reflective photoelectric sensors. In such embodiments, each photoelectric sensor includes a light transmitter, such as an infrared or laser light transmitter, and a photoelectric receiver. In some embodiments, the transmitter is positioned on a first wall and the receiver is positioned directly opposite the transmitter on an opposing wall. In other embodiments, the transmitter and receiver are positioned together in one location on a first wall, and a reflector is positioned directly opposite the transmitter/receiver on an opposing wall. In various embodiments, the transmitter emits a light beam, which is received, at least at times, by the receiver. In some embodiments, the sensor 230 is configured to sense when the beam is interrupted, such interruption being indicative of a visitor passing through the beam.

The photoelectric sensor 230 may be positioned at any suitable position within the exhibition space; for example, in one embodiment, each photoelectric sensor is positioned approximately 24 inches above the floor. In other embodiments, each photoelectric sensor may be positioned between 2 and 30 inches above floor level or at any other height that is reliably blocked by each passing visitor. In some embodiments, the photoelectric transmitter, receiver, and optional reflector are positioned within a door frame or other entryway leading to an exhibit such that the sensor 230 detects whenever a visitor enters through the entryway. In other embodiments, the photoelectric sensor components are positioned on walls perpendicular to the entryway. In one such embodiment, the photoelectric sensor components are positioned such that the emitted detection beam extends across the exhibition space approximately 24 inches from the entryway. In such an embodiment, the system 200 may be configured so that the image capture device 210 captures the image several seconds (e.g., 3-6 seconds) after the visitor crosses over the detection beam. In other embodiments, the emitted detection beam is positioned within the exhibition space approximately 6 to 60 inches, or any other desired distance, from the entryway. The programmed length of delay between the triggering event and image capture may be selected based on the distance between the detection beam and the exhibit. As shown in FIG. 4, in some embodiments, two photoelectric sensors 230 are provided on perpendicular walls. Such an embodiment may be desirable if the placement of the exhibit requires a visitor to walk a path from the entryway to the exhibit that is non-perpendicular to the entryway. In some such embodiments, a triggering signal is not generated until the visitor has passed through both detection beams.

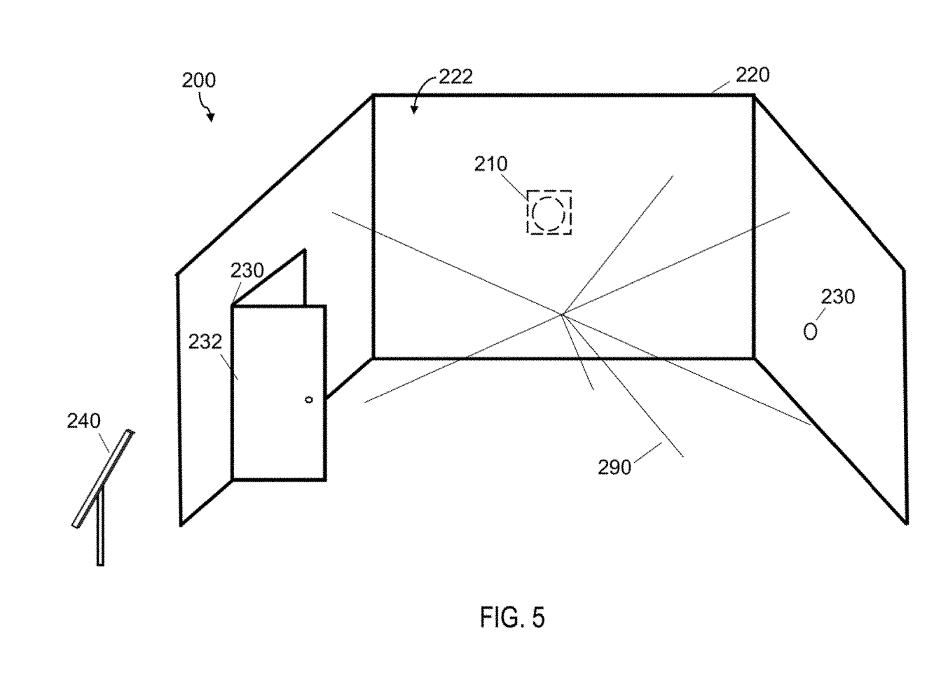

An additional example of an image capture system 500 is provided in FIG. 5. In the provided example, the exhibit 290 is an art installation (brined of a plurality of flexible strands of light, which are stretchable and manipulatable by the visitor. In the example, the entire support structure 220 has a front surface 222 formed of a mirror. Such an arrangement creates an immersive environment filled with reflections of the visitor and light. In some embodiments, the support structure 220 defines an enclosure and forms two, three, four, or more walls of the enclosure. In some such embodiments, at least the wall housing the image capture device 210 has a front surface 222 formed of a two-way mirror so as to enable the image capture device 210 to capture, through the two-way mirror, one or more images of the visitor experiencing the immersive environment.

In the embodiment of FIG. 5, a sensor 230 is positioned on the door 232 or door frame. The sensor 230 may include, for example: a motion sensor such as an accelerometer configured to detect changes in acceleration of the door or a gyroscope configured to detect an orientation of the door; an acoustic sensor configured to detect the sound of the door closing; or a pressure sensor configured to detect the pressure of the closing door against the door frame. Such sensor configurations enable the system 200 to detect when a visitor has entered into the exhibition space through the door 232.

Additionally or alternatively, the system 200 may include a second sensor 230 comprising a motion detector, such as the sensor 230 coupled to the far right wall. The motion sensor may be configured to detect the motion of a visitor within the exhibition space, and more particularly, the motion of a visitor at or near the exhibit 290. The motion detector may be, for example, a passive infrared sensor sensitive to the visitor's skin temperature, a microwave sensor, an ultrasonic sensor, or any other suitable motion detector.

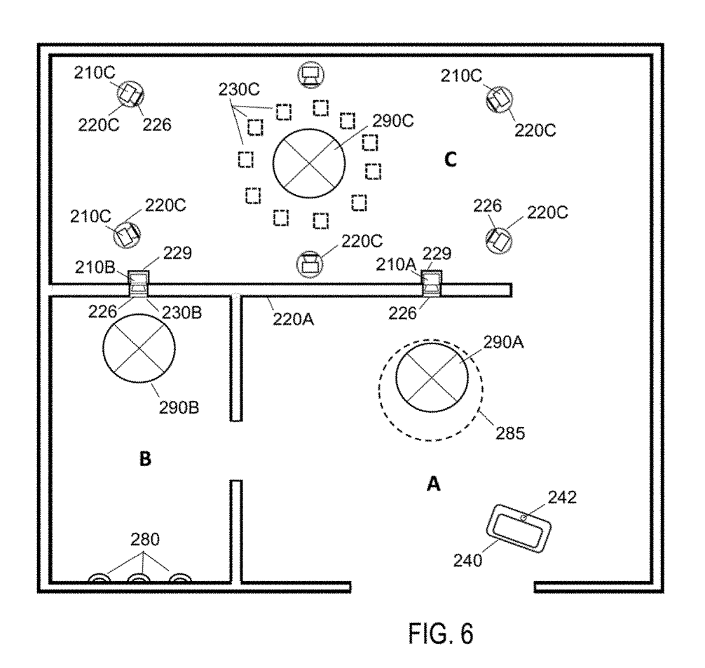

Additional non-limiting examples of sensors 230 and other components of the image capture system 200 are provided in the schematic floorplan shown in FIG. 6. The system 200 of FIG. 6 includes a plurality of exhibits 290 separated by a plurality of support structures 220. In particular, the system 200 includes exhibit spaces A, B, and C, which are partially enclosed and contain exhibits 290A, 290B, and 290C, respectively. Each exhibit 290 includes one or more image capture devices 210 integrated into one or more support structures 220 and oriented towards the respective exhibit. For example, the image capture device 210A of exhibit space A is integrated into support structure 220A and oriented to capture images of exhibit 290A. The image capture device 210B of exhibit space B is also integrated into support structure 220A, but it is positioned to capture images of exhibit space B. In exhibit space C, a plurality of pillars are provided. Each pillar serves as a support structure 220C and houses an image capture device 210C within a port. As in other embodiments, each support structure 220 includes a transparent covering 226 positioned over a front side of the port. The transparent covering 226 may be affixed or removable and is substantially flush with, or recessed from, a surface of the support structure 220 so as to protect, the lens of the image capture device 210. The back portion of the image capture device 210 may not be flush with a surface of the support structure 220. For example, as shown, in some embodiments, a camera support box 229 may be provided, which extends from a back surface of the support structure 220A, is removably or securably attached to the support structure 220A, and houses at least a portion of an image capture device 210A, 210B.

The system 200 of FIG. 6 includes a user input device 240 positioned at the entryway of exhibition space A. The user input device 240 includes a computing unit and a touchscreen displaying a graphical user interface. In some embodiments, the user input device 240 also includes a front-facing camera 242 configured to take a photograph of each visitor entering contact information into the user input device 240. In such embodiments, a computing unit integrated into or communicatively coupled to the user input device 240 tend the various image capture devices 210A, 210B, and 210C is configured to perform facial recognition, text recognition (for example, of text provided on a visitors apparel), or other image recognition of each captured image. The image recognition enables the system 200 to identify the one or more visitors in each image, match the appropriate contact information to each identified visitor, and share each image with the visitors captured in the image. Such a system is configured to ensure that the correct images are sent to the correct visitors even when many visitors are in attendance. In alternative embodiments, each exhibit is provided with a separate user input device and may be configured for interaction with one visitor at a time.

As also shown in FIG. 6, in some embodiments, a lighting device 280 is provided on a wall opposing the image capture device 210. The lighting device 280 is positioned behind the exhibit 290B and the interacting visitor in order to create a bandit effect in the images captured by the image capture device 210B. In other embodiments, the lighting device 280 may be integrated into or coupled to any wall, floor, or ceiling in the exhibition space to create any desired lighting effects. For example, in exhibition space A, the lighting device (not visible) is positioned in, or coupled to, a ceiling overhead between the image capture device 210A and the exhibit 290A, and the lighting device is aimed to create an illumination field 285 sized to illuminate both the exhibit and a proximately located visitor.

The exhibition spaces and exhibits may be any suitable size and shape. For example, each exhibition space may be sized to fit one visitor, one to ten visitors, dozens of visitors, hundreds of visitors, or any other desired number of visitors at a time. In one non-limiting embodiment, an exhibition space ranges between 4 feet and 1 feet in both length and width, and the distance between the image capture device 210 and the intended location of the visitor experiencing the exhibit is 2 feet to 4 feet. In other embodiments, the image capture device 210 may be closer to, or farther from, the visitor experience location.

A plurality of sensor and activation types are present within the system 200 of FIG. 6. For example, in exhibition space A, the user input device 240 serves as the activation module, and a visitor's entry of contact information into the user input device 240 serves as the triggering event. In some embodiments, the image capture device 210A is configured to capture an image of the exhibit 290A and any proximately located visitors after a delay of 3-15 seconds following a visitor's submission of contact information.

As another example, in exhibition space B, the image capture device 210B serves as its own activation module. In such embodiments, the image capture device 210B is a digital video camera, which is configured to capture images and function as a motion sensor. To serve as a motion sensor, the digital video camera is programmed to always record and monitor for motion in its field of view. Motion in the field of view may serve as the triggering event, causing the image capture device 210B to generate a trigger signal or command. In response to the trigger signal, the image capture device 210B may be activated to begin storing, transmitting, sharing, and/or performing image recognition on subsequently captured video images.

In exhibition space C, a plurality of pressure sensors 230C are positioned on, or integrated into, a rug or other flooring. The pressure sensors 230C are positioned all around the exhibit 290C and configured to detect when a visitor has stepped onto an area of the floor proximate to the exhibit 290C. In some embodiments, a plurality of image capture devices 210C are provided, and the plurality of pressure sensors 230C or one or more alternate sensors 230 are configured to sense not only when a visitor approaches the exhibit 290C but from what direction. In such embodiments, detection of a visitor by a sensor may cause activation of an image capture device located on a substantially opposing side of the exhibit, relative to the visitor, so as to ensure that any captured images include both the exhibit and the face of the visitor experiencing the exhibit.

As mentioned above, the support structure 220 of various embodiments includes a port hole extending through the support structure 220 and sized to fully or partially house the image capture device 210. The port hole may be any suitable size and shape for accommodating the image capture device 210 or at least the lens 212 of the image capture device 210. For example, the port hole may have a rectangular or circular cross-section or it may be any other suitable shape. In some embodiments, the length or diameter of the cross-section is 0.5 inches, 24 inches, or any value therebetween. In other embodiments, a wider or narrower port hole may be provided.

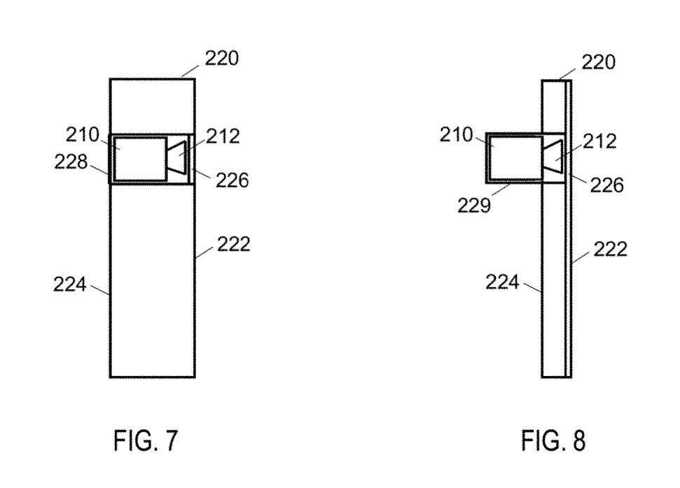

In some embodiments, as shown in FIG. 7, the support structure 220 is thick enough to house the entire image capture device 210. In some such embodiments, a door or other movable or removable covering 228 is provided on a rear surface 224 of the support structure 220 to cover the port hole and provide access to the image capture device 210. In other embodiments, such as shown in FIG. 8, the support structure 220 is not thick enough to house the entire image capture device 210. In such embodiments, all or a portion of the lens 212 of the image capture device 210 is positioned within the port hole. The remainder of the image capture device 210 may be positioned within a camera support box 229 attached to, and extending from, the rear surface 224 of the support structure 220. The camera support box 229 may include a door or other movable or removable covering for accessing the image capture device 210, or the image capture device 210 may be accessed by removing the camera support box 229 from the support structure 220.

Additionally, as shown in FIGS. 7 and 8, the front of the port hole is covered by a transparent covering 226. The transparent covering 226 may be removable or permanently affixed to the support structure 220. In some embodiments, the transparent covering 226 is sized to fit within the port hole and is flush with the front surface 222 of the support structure 220, as in FIG. 7. In other embodiments, the transparent covering 226 is attached to the front surface 222 and substantially flush with the front surface 222. In other embodiments, such as in FIG. 8, the transparent covering extends the length of the support structure 220 and forms the front surface 222 of the support structure 220.

These non-limiting examples are provided for illustrative purposes only; it will be appreciated by one skilled in the art that any number and configuration of user input devices, support structures, activation devices, image capture devices, and/or exhibits may be provided within an image capture system 200.

### Methods of Operation

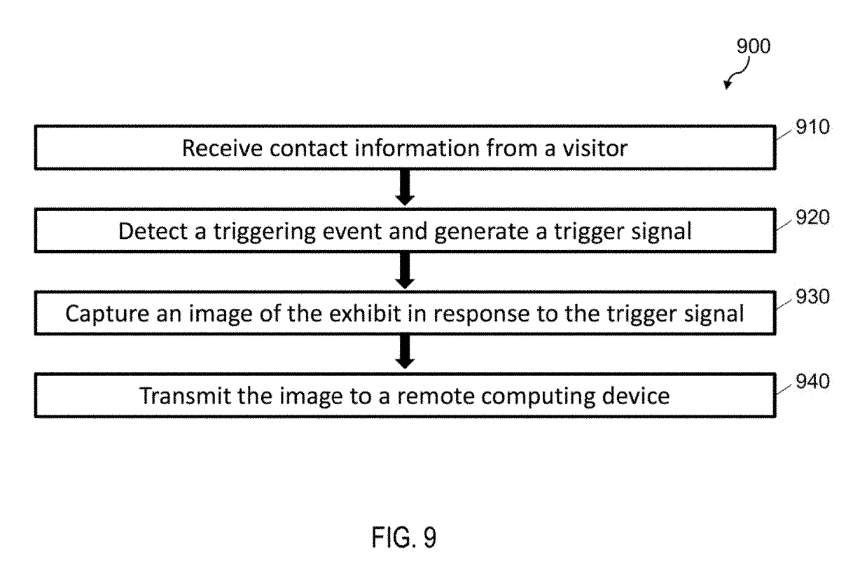

One example of a method for capturing and sharing images of a visitor's experience with an exhibit is provided in FIG. 9. By performing such a method, an image capture system can document and share an image of a visitor experiencing an exhibit without distracting from, interfering with, or interrupting the individual's experience or the experience of others. Such a method may be performed by any suitable image capture system such as, for example, any of the image capture system embodiments described above.

The method 900 is performed by one or more computerized devices within the image capture system 200. Instructions for executing such a method may be stored within memory on one of more of the computerized devices.

As shown at block 910, in some embodiments, the method 900 includes receiving contact information from a visitor. The contact information is received on a user input device. In some embodiments, the visitor is prompted by a graphical user interface to enter the contact information, and a user input mechanism is manipulatable by the visitor to enter the contact information. A computing unit of the user input device may store instructions for the graphical user interface, command a display screen to display the graphical user interface, and recognize and store the contact information entered from the visitor.

At block 920, a triggering event is detected and a trigger signal is generated. The triggering event may be detected, and the trigger signal generated, by the computing unit of the user input device, a sensor, or other activation device. The same computing unit may additionally transmit the trigger signal directly to the image capture device or to an intermediate computing device, which in turn transmits the trigger signal to the image capture device. In some embodiments, the device that generates the trigger signal and/or transmits the trigger signal to the image capture device waits a preset amount of time before generating or transmitting the trigger signal. The preset amount of time may be 5, 10, or 30 seconds or any other desired time.

The method 900 further includes capturing an image of the exhibit in response to the trigger signal, as shown at block 930. In various embodiments, capturing the image is performed by the image capture device. Capturing the image, as performed by the computing unit of the image capture device, involves automatically activating an imaging sensor and lens so that they cooperate to take a photograph or record a video. Capturing the image may also involve auto-calibrating or auto-focusing the components of the image capture device to capture a clear and desirable image. In some embodiments, the image capture device waits a preset amount of time between receiving the trigger signal and capturing the image. In various embodiments, capturing the image is appropriately timed so that both the exhibit and the visitor experiencing the exhibit are in the captured image. In various embodiments, the captured image is stored by a computing unit integrated into or coupled to the image capture device.

At block 940, the captured image is transmitted to a remote computing device. In some embodiments, both the captured image and the contact information of the visitor are transmitted to a network computing device for storage and sharing purposes. In other embodiments, the captured image is transmitted to a personal computing device of the visitor using the contact information.

### Methods of Interaction and Use

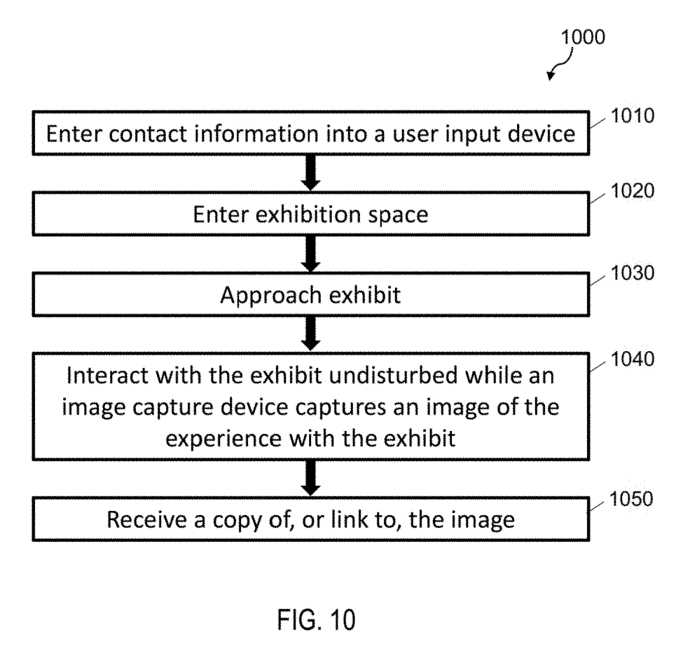

While a visitor to an exhibit may interact with the various image capture systems in any number of suitable ways, one example embodiment of a method of interacting with an image capture system is provided in FIG. 10. In various embodiments, the methods of visitor interaction with the image capture system are largely passive such that the visitor may interact with the exhibit without being distracted or interrupted by the image capture system.

In some embodiments of a method of interaction 1000, the visitor: enters contact information into a user input device, as shown at block 1010; enters the exhibition space, as shown at block 1020; approaches the exhibit, as shown at block 1030; and views, listens to, touches, or otherwise interacts with the exhibit; as shown at block 1040. One or more of these steps may serve as a triggering event, prompting the image capture system to activate the image capture device and capture an image of the visitor with the exhibit as the visitor experiences the exhibit. In various embodiments, one or more photographic or video images are captured while the visitor continues to interact with the exhibit undisturbed by the image capture system. In some embodiments, the visitor may be entirely unaware of the image capture system. As shown at block 1050, in some embodiments, the visitor receives a copy of, or a link to, the one or more captured images of the visitor with the exhibit. The copy or link may be received on a personal computing device of the visitor. In some embodiments, the copy or, link to the images is transmitted to the visitor's computing device while the visitor is still within the exhibition space. In other embodiments, transmission is delayed until the visitor leaves the exhibition space.

The examples described herein show, by way of illustration and not of limitation, specific embodiments in which the subject matter may be practiced. Other embodiments may be utilized and derived therefrom, such that modifications may be made without departing from the scope of this disclosure. This disclosure is intended to cover any and all adaptations or variations of various embodiments, and it will be readily apparent to those of ordinary skill in the art, in light of the teachings of these embodiments, that numerous changes and modifications may be made without departing from the spirit or scope of the appended claims.

What is claimed is:

1. A system for capturing and sharing an image of a visitor experiencing an exhibit, the system comprising:
a user input device configured to receive contact information from a visitor;
an image capture device coupled to a support structure located on a perimeter of or within an exhibition space, the image capture device comprising an image sensor and a lens,
wherein the image capture device is oriented such that an exhibit within the exhibition space is in a field of view of the lens,
wherein the image capture device is configured to capture an image of the visitor with the exhibit in response to receiving a trigger signal, and
wherein the user input device or an activation device is configured to generate the trigger signal in response to detecting a triggering event, the triggering event being associated with the visitor preparing to experience, or experiencing, the exhibit; and
a communication computing device forming a portion of, or communicatively coupled to, the image capture device, wherein the communication computing device is configured to transmit the image to a remote computing device.

2. The system of claim 1, further comprising a light oriented to illuminate one or both of the visitor and the exhibit when the visitor is positioned proximate to the exhibit.

3. The system of claim 1, wherein the user input device comprises a display screen having a graphical user interface displayed thereon, and one or more of a keyboard, touch-responsive technology in the display screen, a mouse, and a trackpad.

4. The system of claim 1, wherein the contact in received at the user input device comprises one or more of: a mobile telephone number, an email address, and a social media user name.

5. The system of claim 1, wherein the support structure comprises a wall, pillar, fence, gate, pole, or other partition.

6. The system of claim 1, wherein the exhibition space comprises any three-dimensional space in which the exhibit is located.

7. The system of claim 6, wherein the exhibit is an event, destination, site, or object of interest.

8. The system of claim 6, wherein the exhibit comprises an art display or installation, a museum display or installation, a musical, theatrical, or other artistic performance, an animal, a scenic vista, a sporting competition, or other attraction.

9. The system of claim 1, wherein the image capture device is configured to capture one or more of: photographs and videos.

10. The system of claim 1, wherein the image capture device comprises a digital single lens reflex (DSLR) camera.

11. The system of claim 1, wherein the image sensor comprises one or more of: a charge-coupled device (CCD) and a complementary metal-oxide-semiconductor (CMOS).

12. The system of claim 1, wherein the lens of the image capture device comprises a 14-24 mm lens, a fisheye lens, or other lens configured for capturing wide angles.

13. The system of claim 1, wherein the support structure comprises a front surface facing the exhibit and a rear surface facing away from the exhibit, and wherein the image capture device is integrated into the support structure such that the lens is protected by a transparent covering flush with, or forming, the front surface and the image capture device is accessible from the rear surface.

14. The system of claim 1, wherein the user input device is configured to generate trigger signal, and the triggering event comprises receipt of the contact information from the visitor via the user input device.

15. The system of claim 1, wherein the activation device comprises a sensor and the triggering event comprises movement or positioning of the visitor at a sensor-monitored location of the exhibition space.

16. The system of claim 15, wherein the sensor comprises one or more of: a motion sensor, a photoelectric sensor, a pressure sensor, and an acoustic sensor.

17. The system of claim 1, wherein the image capture device is programmed to delay capture of the image by a pre-programmed time following receipt of the trigger signal.

18. The system of claim 1, wherein:
the communication computing device is additionally integrated into or communicatively coupled to the user input device and optionally the activation device; and
the communication computing device is configured to relay trigger signals to the image capture device, receive the image from the image capture device, receive contact information from the user input device, and transmit the image to the remote computing device.

19. The system of claim 1, wherein the remote computing device comprises one or both of: a server on which the image is stored, and a personal computing device of the visitor.

20. The system of claim 19, wherein the communication computing device is further configured to transmit the contact information of the visitor to the server, and the server is configured to transmit an electronic link to the stored image to the personal computing device of the visitor.
